(19) United States
(12) Patent Application Publication
(10) Pub. No.: US 2008/0056314 A1
(43) Pub. Date: Mar. 6, 2008

(54) High-power laser-diode package system

(75) Inventors: Steven M. Coleman, Bedford, NH (US); Edward F. Stephens, Golden Eagle, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(73) Assignee: Northrop Grumman Corporation

(21) Appl. No.: 11/515,093

(22) Filed: Aug. 31, 2006

(51) Int. Cl. H01S 3/04

(52) U.S. Cl. 372/36

(57) ABSTRACT

A system includes a laser-diode bar comprising an emitting surface and a reflective surface opposing the emitting surface. The laser-diode bar includes a positive-side surface and a negative-side surface opposing the positive-side surface for conducting electrical energy through laser-diode bar. The system also includes a heat sink thermally coupled to the laser-diode bar. The heat sink is made of a material selected from the group consisting of Skeleton-cemented diamond and diamond-copper composite. The system also includes a heat spreader interposed between the heat sink and the laser-diode bar. The heat spreader includes a first surface thermally interfacing the positive-side surface of the laser-diode bar. The first surface is substantially smoother than a surface on the heat sink and includes an electrically conductive material for conducting the electrical energy into the laser-diode bar.

### CROSS-REFERENCE TO RELATED APPLICATIONS

This patent application incorporates by reference the entire disclosure of U.S. Pat. No. 6,728,275.

### BACKGROUND

1. Technical Field

The present invention relates generally to laser diodes and, in particular, to systems and methods for cooling laser diodes.

2. History of Related Art

Semiconductor laser diodes are typically quite small. The widths of their active regions are typically a submicron to a few microns. Their heights are usually no more than a fraction of a millimeter. Internal reflective surfaces, which produce emission in one direction, may be formed by cleaving a substrate from which the laser diodes are produced.

While semiconductor laser diodes have many beneficial applications, some of these uses have been restricted due to thermally related problems. These problems are associated with a large heat dissipation per unit area of the laser diodes, which results in elevated junction temperatures and stresses induced by thermal cycling. Laser-diode efficiency and service life may decrease as junction operating temperatures increase.

Furthermore, an emitted wavelength of a laser diode is a function of its junction temperature. Thus, when a specific output wavelength is desired, maintaining a constant junction temperature is important. For example, for every 3.5°-4.0° C. deviation in the junction temperature of a typical AlGaAs laser diode, the wavelength shifts 1 nm. Accordingly, controlling the junction temperature by properly dissipating the heat is desirable.

When solid-state laser rods or slabs are pumped by laser diodes, heat dissipation becomes even more problematic due to the plurality of densely packed diodes. As the packing density of individual laser diodes increases, space available for heat extraction from the individual laser diodes decreases, thus aggravating the problem of heat extraction from arrays of individual diodes.

Laser-diode systems must therefore utilize an effective heat-transfer mechanism to operate efficiently. Directly bonding a laser diode to a heat sink with a rough surface can present challenges. For example, when a solid surface is placed against a relatively flat side of the laser-diode bar where heat is being conducted or produced, the heat can be efficiently removed unless there is a void,or irregularity, which could result in heat-transfer irregularities. When these voids are present, the thermal resistance at the interface between the laser diode bar and the heat sink increases leading to localized heating and, potentially, failure of the laser diode bar.

### SUMMARY OF THE INVENTION

A system includes a laser-diode bar comprising an emitting surface and a reflective surface opposing the emitting surface. The laser-diode bar includes a positive-side surface and a negative-side surface opposing the positive-side surface for conducting electrical energy through laser-diode bar. The system also includes a heat sink thermally coupled to the laser-diode bar. The heat sink is made of a material selected from the group consisting of Skeleton-cemented diamond and diamond-copper composite. The system also includes a heat spreader interposed between the heat sink and the laser-diode bar. The heat spreader includes a first surface thermally interfacing the positive-side surface of the laser-diode bar. The first surface is substantially smoother than a surface on the heat sink and includes an electrically conductive material for conducting the electrical energy into the laser-diode bar.

A system includes a laser-diode bar and a heat spreader having an electrically-conductive first surface adjacent to a first side of the laser-diode bar for conducting electrical energy to the laser-diode bar. The system also includes a structure having an electrically-conductive surface adjacent to a second side of the laser-diode bar for conducting electrical energy from the laser-diode bar. A non-electrically-conductive substrate has a first interface contacting to the heat spreader and a second interface contacting to the structure. The system also includes a high thermal conductivity heat sink adjacent to a second surface of the heat spreader for removing heat from the laser-diode bar.

The above summary of the present invention is not intended to represent each embodiment or every aspect of the present invention.

### BRIEF DESCRIPTION OF THE DRAWINGS

A more complete understanding principles of the present invention may be obtained by reference to the following Detailed Description, when taken in conjunction with the accompanying Drawings, wherein:

FIG. 1 is a perspective view of a laser-diode package;

FIG. 2 is an exploded view of layers of the laser-diode package of FIG. 1;

FIG. 3 is a side view of a laser-diode package;

FIG. 4 illustrates an array of laser-diode packages; and

FIG. 5 is a side view of a laser-diode package of FIG. 3 utilizing a macrochannel cooler.

### DETAILED DESCRIPTION OF ILLUSTRATIVE EMBODIMENTS OF THE INVENTION

Various embodiments of the present invention will now be described with reference to the accompanying drawings. The invention may, however, be embodied in many different forms and should not be constructed as limited to the embodiments set forth herein; rather, the embodiments are provided so that this disclosure will be thorough and complete, and will fully convey the scope of the invention to those skilled in the art.

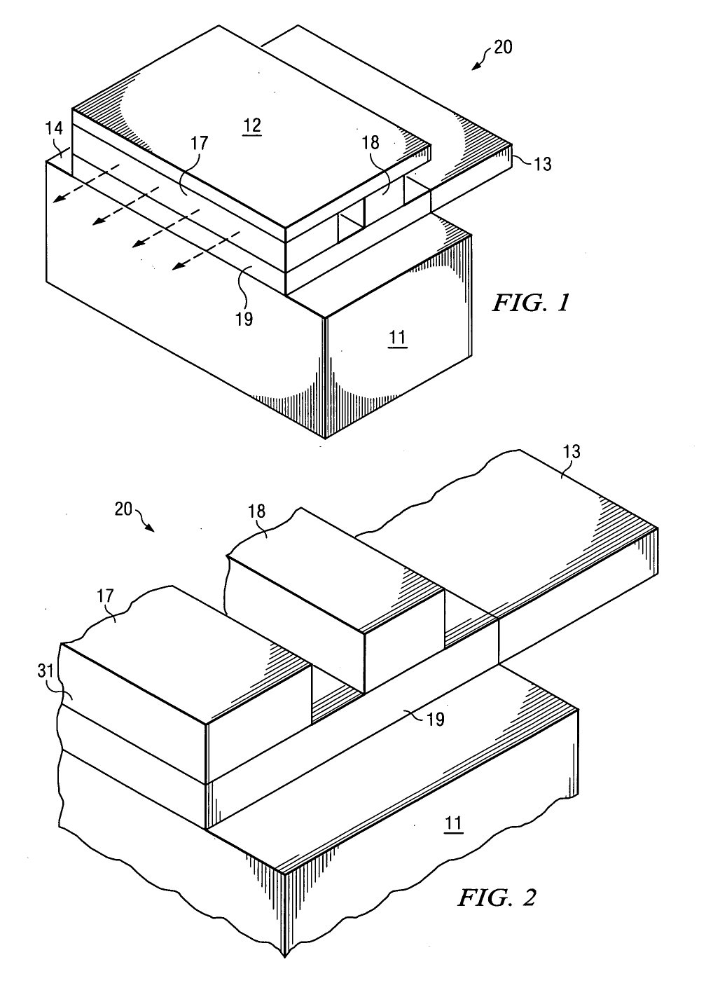

Referring now to FIG. 1, a perspective view of a laser-diode package 20 is shown. In FIG. 1, a heat spreader 19 is shown interposed between a laser-diode bar 17 and a heat sink 11. Preferably, the heat sink 11 may be formed, for example, of Skeleton-cemented diamond (“ScD”) or a diamond-copper composite. In a typical embodiment, any relatively large geometry (e.g., 25×25×8 mm) material of thermal conductivity greater than 390 W/m*K (i.e., greater than copper) can be used to form the heat sink 11. Skeleton-cemented diamond can have a thermal conductivity of 600 W/m*K or higher. These materials used for the heat sink 11 have much greater thermal conductivities than, for example, copper tungsten (CuW) or copper-molybdenum (CuMo) and allow for a better coefficient of thermal expansion (“CTE”) match to diamond and to GaAs than does copper.

Depending on the application, the heat sink 11 may be used to conduct electricity between a positive contact 13 and the laser-diode bar 17 or may be kept electrically isolated from the laser-diode bar 17. In the laser-diode package 20, the positive contact 13 is electrically coupled to the heat spreader 19, the heat spreader 19 being metallized on at least two surfaces in order to provide electrical conductivity between the positive contact 13 and the laser-diode bar 17. However, in various other embodiments, the heat sink 11 may be used to conduct electricity, for example, by electrically coupling the positive contact 13 to a metallized portion of the heat sink 11, electrically coupling the metallized portion of the heat sink 11 to a metallized portion of the heat spreader 19, and electrically coupling the metallized portion of the heat spreader 19 to the laser-diode bar 17. When the heat sink 11 is made of an electrically nonconductive material, one way of metallizing a portion of the heat sink 11 is to apply an adhesive layer to the heat sink 11 (e.g., tungsten or nickel chromium) and add a gold-plated layer, for example, to a top surface 14 of the heat sink 11. Those having skill in the art will appreciate that numerous configurations of the positive contact 13 and metallization of portions of the heat sink 11 and the heat spreader 19 may be employed without departing from principles of the invention.

The heat spreader 19 is typically thermally conductive and electrically non-conductive. For example, the heat spreader 19 may be formed using diamond, silicon carbide (“SiC”), or other materials exhibiting desired characteristics such as, for example, high thermal conductivity, relatively smooth surfaces, well-defined edges, and high electrical resistivity. In various embodiments, the heat spreader 19 may be formed of a crystalline or polycrystalline type material and may be grown in such an orientation that cleave planes of the heat spreader 19 are parallel to facets of the laser-diode bar 17.

Using crystalline or polycrystalline materials to form the heat spreader 19 allows for defined corners and edges to be fabricated. For example, SiC and diamond can each be formed with sharp edges that may provide advantages over directly bonding the laser-diode bar 17 to the heat sink 11. Using diamond or SiC to form the heat spreader 19 may provide an advantage for bonding to GaAs in terms of CTE. A better CTE match may in some embodiments allow the use of harder solders that may be less susceptible to thermo-migration, electro-migration, and mechanical distortion, which may increase the life of the laser-diode package 20. In various embodiments, a hard solder, such as eutectic AuSn, may then be used to attach the heat spreader 19 to the heat sink 11.

Because the heat spreader 19 is interposed between the laser-diode bar 17 and the heat sink 11, using a material to form the heat spreader 19 that has a high thermal conductivity and is electrically insulating, semi-insulating, or of high resistivity allows the heat sink 11 to be fabricated from a material of any electrical conductivity without necessarily being biased by a laser-diode drive voltage. As noted above, the heat spreader 19 may be metallized on one or more sides to electrically couple the laser-diode bar 17 to the positive contact 13.

Other embodiments may include metallizing all or part of the heat sink 11, including a top surface 14, in addition to metallizing all or part of the heat spreader 19. In that manner, the positive contact 13 can be electrically coupled to the laser-diode bar 17 through some combination of metallized surfaces of the heat spreader 19 and the heat sink 11.

Referring now to FIG. 2, a detailed exploded perspective view of layers of the laser-diode package 20 is shown. In FIG. 2, the laser diode bar 17 has an emitting surface 31 that runs substantially along the bottom of the laser-diode package 20. The heat spreader 19 is interposed between the laser diode bar 17 and the heat sink 11. An electrically nonconductive substrate 18 is also shown. The substrate 18 can be made of any electrically nonconductive material, one such material contemplated being BeO because it is both electrically nonconductive and thermally conductive. The substrate 18 serves to prohibit the heat spreader 19 from creating unwanted forces on the laser-diode bar 17, which could occur through a cantilevering effect if the substrate 18 were not present.

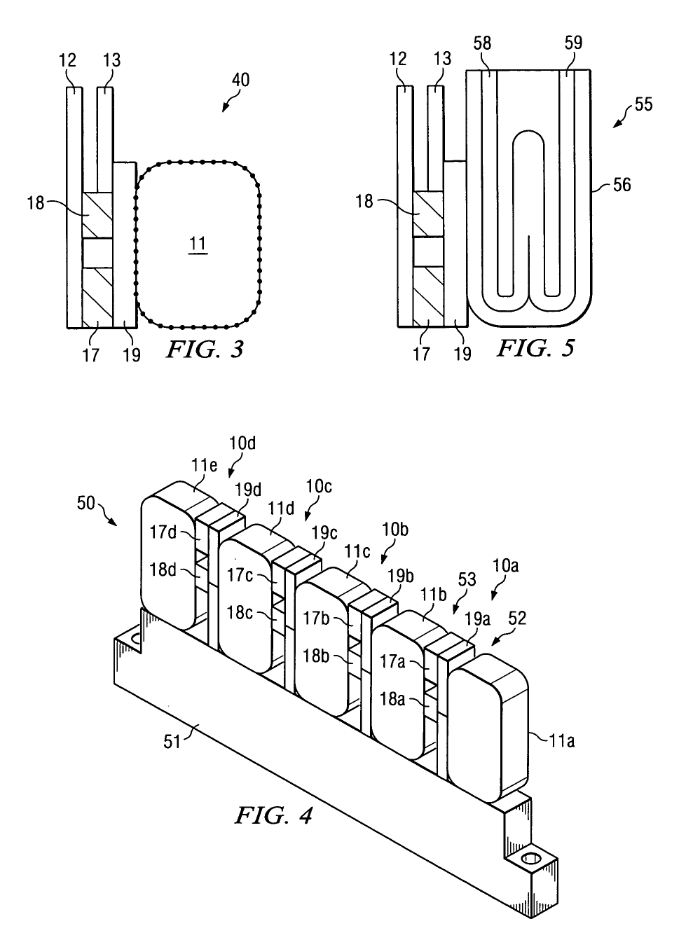

Referring now to FIG. 3, a side view of an illustrative laser-diode package 40 is shown. One problem that may arise when using materials with high thermal conductivities (e.g., Skeleton cemented diamond or diamond-copper composite) to form the heat sink 11 is that there may be pores and voids in a surface of the heat sink 11 causing a rough contact area or rounded edges. If mounted directly to the laser-diode bar 17, irregularities of a contacting surface of the heat sink 11 may result in voids or openings along the contacting surface of the heat sink 11 against the laser-diode bar 17. Thus, heat may build up at certain spots more than others. The heat spreader 19, when placed between the heat sink 11 and the laser-diode bar 17, serves to overcome these problems.

The heat spreader 19 typically has relatively well-defined edges with angles that approximate right angles for better contact with the laser-diode bar 17. Interposing the heat spreader 19 between the laser-diode bar 17 and the heat sink 11 serves to create a relatively smooth contact surface resulting in isotherms along the laser-diode bar 17 in contact with the heat spreader 19. The substrate 18 is interposed between the heat spreader 19 and a negative contact 12. Depending on the application, the substrate 18 may be of any length to prevent stress on the laser-diode bar 17 or may not be included at all. Additionally, FIG. 3 shows the heat spreader 19 running along the full length of the heat sink 11. However, many other combinations are contemplated.

Referring now to FIG. 4, an illustrative laser-diode package array 50 is shown. The array 50 includes a plurality of laser-diode packages 10a-10d coupled together in series. The array 50 is shown as including four laser-diode bars 17a-17d and five heat sinks 11a-11e, but an array of any size may be created. The negative contact 12 illustrated in FIGS. 1, 3, and 5 has been removed so that a positive side 52 of the laser-diode bar 17a may be attached to the heat spreader 19a and a negative side 53 of the laser-diode bar 17a may be attached directly to a heat sink 11b. The heat sink 11b may be metallized so that it has a smooth surface and can act as a negative contact for the laser-diode bar 17a. The remaining laser-diode packages 10b-d are similarly configured.

In another embodiment, a second heat spreader (not explicitly shown) may be interposed between the heat sink 11b and the laser-diode bar 17a. In this embodiment, the second heat spreader 19 may be metallized in such a way that the heat spreader becomes a negative contact for the laser-diode bar 17a. The laser-diode packages 10a-d can be joined to form the array via any suitable attachment method, including simple mechanical compression, the use of adhesives, thermal grease, soldering, or brazing. In one exemplary embodiment, components may be held in place through soldering to a substrate 51 as illustrated.

Referring now to FIG. 5, a side view of an illustrative laser-diode package 55 is shown. The laser-diode package 55 is similar to the laser-diode package 40 of FIG. 3, in that the heat spreader 19, the laser-diode bar 17, the substrate 18, the positive contact 13, and the negative contact 12 are included therein. However, unlike the laser-diode package 40, the laser-diode package 55 includes a heat sink 56 that includes macrochannels receive a fluid to aid in heat transfer away from the heat sink 56. An inlet 58 and an outlet 59 allow the fluid to flow into and out of the heat sink 56 and transfer heat away from the laser-diode package 55. The laser-diode package 55 may be used alone or in an array as illustrated, for example, in FIG. 4, as design considerations dictate.

Those having skill in the art will appreciate that the electrically non-conductive substrate need not necessarily be formed of BeO. The substrate 18 may take many different forms. For example, in various embodiments of the invention, the substrate 18 may be a forward-biased diode, such as the on shown in U.S. Pat. No. 6,728,275, which is hereby incorporated by reference in its entirety. Or, the substrate 18 can be an active device used, for example, to sense temperature or pressure between the heat spreader 19 and the laser-diode bar 17, while still serving to prevent unwanted forces on the laser-diode bar 17.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

What is claimed is:

1. A system comprising:
a laser-diode bar comprising an emitting surface and a reflective surface opposing the emitting surface, the laser-diode bar including a positive-side surface and a negative-side surface opposing the positive-side surface for conducting electrical energy through laser-diode bar;
a heat sink thermally coupled to the laser-diode bar, the heat sink being made of a material selected from the group consisting of Skeleton-cemented diamond and diamond-copper composite; and
a heat spreader interposed between the heat sink and the laser-diode bar, the heat spreader comprising a first surface thermally interfacing the positive-side surface of the laser-diode bar, the first surface being substantially smoother than a surface on the heat sink and including an electrically conductive material for conducting the electrical energy into the laser-diode bar.

2. The system of claim 1, wherein a heat spreader edge of the heat spreader that is directly adjacent to the emitting surface is substantially parallel to and directly contacts substantially all of an edge of the emitting surface of laser-diode bar.

3. The system of claim 1, wherein the heat spreader is formed of a crystalline structure and has cleave planes parallel to a positive-side surface of the laser-diode bar.

4. The system of claim 3, wherein the heat spreader is metallized on at least one side that contacts the positive-side surface.

5. The system of claim 1, wherein the heat sink is electrically isolated from the laser-diode bar.

6. The system of claim 1, wherein the heat sink comprises macrochannels adapted for heat-transfer fluid to flow therethrough.

7. The system of claim 1, further comprising a negative contact contacting the negative-side surface of the laser-diode bar.

8. The system of claim 7, further comprising:
a substrate interposed between the heat spreader and the negative contact; and
wherein the substrate is thermally conductive and electrically nonconductive.

9. The system of claim 8, wherein the substrate comprises BeO.

10. The system of claim 8, wherein the substrate fills the entire space between the negative contact and the heat spreader.

11. The system of claim 8, wherein the substrate is spaced apart from the laser-diode bar.

12. The system of claim 1, wherein the heat spreader comprises diamond.

13. The system of claim 1, wherein the heat spreader comprises SiC.

14. A system comprising:
a laser-diode bar;
a heat spreader having an electrically-conductive first surface adjacent to a first side of the laser-diode bar for conducting electrical energy to the laser diode;
a structure having an electrically-conductive surface adjacent to a second side of the laser-diode bar for conducting electrical energy from the laser diode;
a non-electrically-conductive substrate having a first interface contacting the heat spreader and a second interface contacting the structure; and
a high thermal conductivity heat sink adjacent to a second surface of the heat spreader for removing heat from the laser diode, the second surface of the heat spreader opposing the first surface of the heat spreader.

15. The system of claim 14, wherein the heat sink comprises a material selected from the group consisting of Skeleton-cemented diamond and diamond-copper composite.

16. The system of claim 15, wherein the heat spreader is formed of a crystalline structure.

17. The system of claim 15, wherein the heat spreader is diamond or SiC.

18. The system of claim 14, wherein the heat sink is electrically isolated from the laser-diode bar and has a thermal conductivity of at least 600 W/m*K.

19. The system of claim 14, wherein the heat sink comprises macrochannels adapted for a heat-transfer fluid to flow therethrough.

20. The system of claim 14, wherein the non-electrically-conductive substrate comprises BeO.
